(19) United States
(12) Patent Application Publication
(10) Pub. No.: US 2026/0089082 A1
(43) Pub. Date: Mar. 26, 2026

(54) Intermediate System to Intermediate System (IS-IS) Hitless Reboot with Redistributed Routes

(71) Applicant: Arista Networks, Inc., Santa Clara, CA (US)

(72) Inventor: Nikhil GOYAL, Kota (IN)

(21) Appl. No.: 18/897,489

(22) Filed: Sep. 26, 2024

(51) Int. Cl. H04L 45/02; H04L 45/03

(52) U.S. Cl. CPC H04L 45/04; H04L 45/03

(57) ABSTRACT

Techniques are provided for implementing hitless reboot on a network device that runs Intermediate System to Intermediate System (IS-IS) protocol in conjunction with one or more other routing protocols and has route redistribution enabled for redistributing routes learned via the one or more other routing protocols into IS-IS. In certain embodiments, these techniques modify the restart processing performed by the network device to ensure that its IS-IS neighbors correctly maintain the redistributed routes it received from the device via IS-IS prior to the hitless reboot.

### BACKGROUND

A hitless reboot of a network device is a procedure that involves restarting the network device's control plane while keeping its data plane operational. This allows the network device to be upgraded with a new software image, or rebooted into the same software image, without interrupting the flow of network traffic through the device.

Intermediate System to Intermediate System (IS-IS) is a network routing protocol that allows IS-IS enabled network devices, known as IS-IS routers, to learn shortest paths (i.e., routes) to destination devices/networks within an administrative network domain, known as an autonomous system (AS). In some cases, an IS-IS router may run other routing protocols such as Border Gateway Protocol (BGP), Open Shortest Path First (OSPF), Enhanced Interior Gateway Routing Protocol (EIGRP), and/or the like in addition to IS-IS. In these cases, a feature known as route redistribution may be enabled on the device to share, or in other words redistribute, routes learned via those other routing protocols into the IS-IS routing domain.

When a network device that runs IS-IS in conjunction with other routing protocols undergoes a hitless reboot, the device generally needs to reconcile its control plane state for each routing protocol with its neighboring network devices (i.e., neighbors) upon being restarted. If the network device also has route redistribution turned on for sharing routes from those other routing protocols into IS-IS, a problem may occur during the restart process that causes one or more neighbors to inadvertently withdraw the redistributed routes it previously received from the device via IS-IS.

### BRIEF DESCRIPTION OF THE DRAWINGS

With respect to the discussion to follow and in particular to the drawings, it is stressed that the particulars shown represent examples for purposes of illustrative discussion and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 depicts an example network in accordance with certain embodiments of the present disclosure.

FIG. 2 depicts an example network device in accordance with certain embodiments of the present disclosure.

FIG. 3 depicts another example network device in accordance with certain embodiments of the present disclosure.

FIG. 4 depicts a bootup processing workflow in accordance with certain embodiments of the present disclosure.

### DETAILED DESCRIPTION

In the following description, for purposes of explanation, numerous examples and details are set forth in order to provide an understanding of embodiments of the present disclosure. Particular embodiments as expressed in the claims may include some or all of the features in these examples, alone or in combination with other features described below, and may further include modifications and equivalents of the features and concepts described herein.

Embodiments of the present disclosure are directed to techniques for implementing hitless reboot on a network device that runs IS-IS in conjunction with one or more other routing protocols such as BGP, OSPF, EIGRP, etc. and has route redistribution enabled for redistributing routes learned via the one or more other routing protocols into IS-IS. In certain embodiments, these techniques modify the restart processing performed by the network device to ensure that its IS-IS neighbors correctly maintain the redistributed routes it received from the device via IS-IS prior to the hitless reboot.

### 1. Example Network and IS-IS/BGP Router

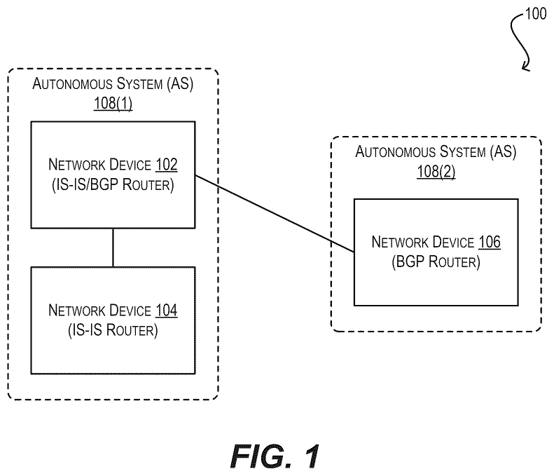

FIG. 1 is a simplified block diagram of an example network 100 in which the techniques of the present disclosure may be implemented. As shown, network 100 includes a network device 102 that is connected to two other network devices 104 and 106. Network devices 102 and 104 are part of a first autonomous system (AS) 108(1) and network device 106 is part of a second AS 108(2). Each AS 108 is a collection of Internet Protocol (IP) networks that are managed and controlled by an entity with a single routing policy. For instance, AS 108(1) may be managed/controlled by one internet service provider (ISP) and AS 108(2) may be managed/controlled by another ISP. The single routing policy dictates how network routes, also known as paths, are managed within the autonomous system and are advertised to other autonomous systems.

In the example of FIG. 1, network devices 102 and 104 both run the IS-IS protocol and thus are designated as IS-IS routers. Network devices 102 and 104 use IS-IS to exchange network topology and reachability information with each other and thereby compute shortest paths to IP prefixes (i.e., destination devices/networks) that are internal to, or in other words are located within, AS 108(1). Further, network devices 102 and 106 both run the BGP protocol and thus are designated as BGP routers. Network devices 102 and 106 use BGP to exchange routing information with each other that includes best paths for IP prefixes located in their respective autonomous systems 108(1) and 108(2).

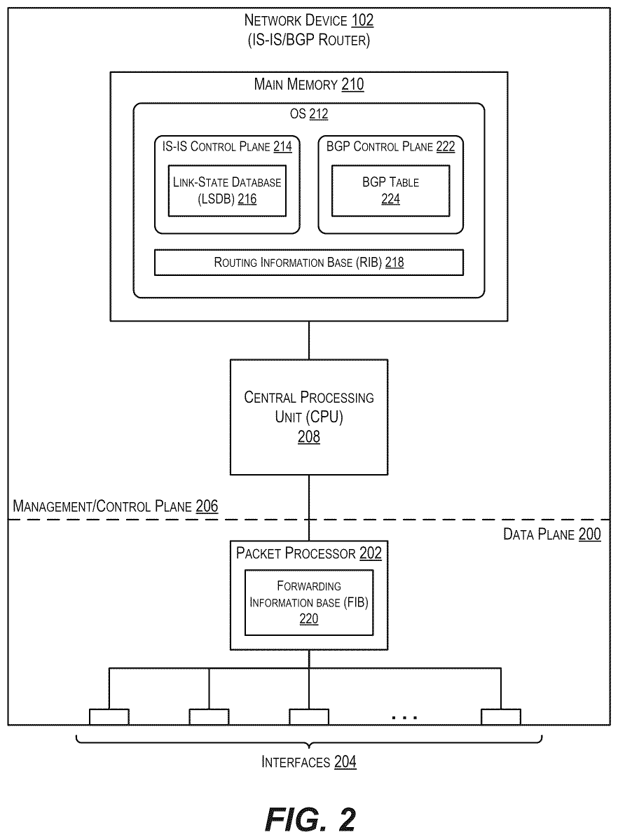

FIG. 2 is a simplified block diagram of the architecture of network device 102 (which operates as both an IS-IS router and a BGP router) according to certain embodiments. As shown in FIG. 2, network device 102 comprises a data plane 200 including a packet processor 202 and a set of front-panel interfaces (i.e., ports) 204. Packet processor 202 is typically an integrated circuit, such as an application-specific integrated circuit (ASIC) or a field-programmable gate array (FPGA), that is responsible for performing line-speed processing of network packets that pass through network device 102 via interfaces 204. This line-speed processing can include, for example, Layer 3 (L3) routing of IP traffic.

Network device 102 also comprises a management/control plane 206 including a central processing unit (CPU) 208 and a main memory 210. CPU 208 is a general-purpose processor that is responsible for managing the configuration/operation of network device 102 and controlling the device's understanding of the network in which it resides. CPU 208 carries out these functions under the direction of an operating system (OS) 212 that runs on CPU 208 from main memory 210.

Because network device 102 operates as an IS-IS router, OS 212 includes an IS-IS control plane 214 that allows the device to exchange network topology and reachability information with other IS-IS routers it is connected to (i.e., IS-IS neighbors), such as network device 104, via the IS-IS protocol. This process generally involves generating, by IS-IS control plane 214, link-state packets (LSPs) containing information about its directly connected links and reachable IP prefixes, storing the generated LSPs in a link-state database (LSDB) 216, and flooding the generated LSPs to the IS-IS neighbors. The process also involves receiving, by IS-IS control plane 214, LSPs from the IS-IS neighbors and storing the LSPs in LSDB 216. Upon receiving and storing a new or updated LSP from one or more neighbors, IS-IS control plane 214 computes the shortest path to each IP prefix identified in LSDB 216 based on the network topology information contained therein and installs the shortest paths into a global routing information base (RIB) 218 as IS-IS routes. IS-IS control plane 214 then propagates the IS-IS routes from RIB 218 to a forwarding information base (FIB) 220 in data plane 200 for use by packet processor 202 in performing line-speed packet forwarding.

Further, because network device 102 also operates as a BGP router, OS 212 includes a BGP control plane 222 that allows the device to exchange routing information with other BGP routers it is connected to (i.e., BGP neighbors), such as network device 106, via the BGP protocol. This process generally involves receiving, by BGP control plane 222, route advertisement packets from its BGP neighbors (where each route advertisement packet includes a route to an IP prefix) and storing this information in a BGP table 224. For each IP prefix in BGP table 224, BGP control plane 222 carries out a path selection procedure to identify the best (or in other words, optimal) path to that IP prefix from among all possible paths in the BGP table, installs the selected best paths into RIB 218 as BGP routes, and propagates the BGP routes from RIB 218 to FIB 220 for use by packet processor 202 in performing line-speed packet forwarding. BGP control plane 222 then advertises the BGP routes in RIB 218 to the BGP neighbors so that they can update their own BGP tables with this information and select best paths accordingly.

Although not shown in FIG. 2, it is assumed that OS 212 of network device 102 has BGP-to-IS-IS route redistribution enabled, which means that some or all of the BGP routes installed by BGP control plane 222 into RIB 218 are redistributed, or shared, into the IS-IS routing domain, thereby allowing those routes to be used by IS-IS routers. This redistribution process generally involves generating one or more LSPs that include reachability information for the IP prefixes of the redistributed routes, storing the LSP(s) in the LSDB, and sending out (i.e., advertising) the LSP(s) to IS-IS neighbors. For example, if RIB 218 includes a BGP route for IP prefix 10.0.0.0/16, BGP-to-IS-IS route redistribution will cause OS 212 to generate a new LSP that identifies 10.0.0.0/16 as an IP prefix that is reachable by network device 102, store the new LSP in LSDB 216, and advertise the new LSP to network device (IS-IS neighbor) 104, thereby enabling device 104 to learn and potentially install this route as an IS-IS route in its respective RIB.

### 1.1 Hitless Reboot

As noted in the Background section, when a network device like device 102 that runs multiple routing protocols undergoes a hitless reboot, the device needs to reconcile its control plane state for each such routing protocol with its neighbors upon being rebooted/restarted. This reconciliation process is referred to as convergence. For IS-IS, BGP, and certain other routing protocols, convergence after a hitless reboot is carried out via Graceful Restart (GR), which is a mechanism that is designed to minimize network disruption. In context of IS-IS, GR generally proceeds as follows:
1. After the control plane of the restarting network device (i.e., restarter) is rebooted as part of the hitless reboot, the restarter broadcasts a set of IS-IS Hello (IIH) packets with the Restart Request (RR) bit set, thereby signaling that it is entering a graceful restart.
2. In response to receiving the IIH packets with the RR bit set, each IS-IS neighbor generates and advertises a Complete Sequence Number PDU (CSNP) an LSP containing its current IS-IS protocol state (i.e., the contents of its LSDB) to the restarter.
3. Upon receiving these CSNPs and LSPs from all IS-IS neighbors, the restarter updates its LSDB with the contents of the received LSPs, generates a post-restart LSP based on its updated LSDB, and advertises the post-restart LSP to the IS-IS neighbors so that they can update their respective LSDBs with this information. The restarter also performs shortest path computation and updates its RIB with any newly determined IS-IS routes as needed. At this point, IS-IS convergence is complete from the perspective of the restarter and the restarter can resume normal operation.

One problem that can occur in the conventional IS-IS GR process above pertains to a scenario in which route redistribution from another routing protocol to IS-IS is enabled on the restarter. For example, assume the restarter is network device 102 of FIGS. 1 and 2, which has BGP-to-IS-IS route redistribution enabled as mentioned previously. In this scenario, upon bootup, BGP control plane 222 will synchronize the BGP routes in RIB 218 to LSDB 216 after it has completed BGP convergence, thereby enabling IS-IS control plane 214 to (at least in theory) include those routes as redistributed routes in the post-restart LSP. However, consider the following possible sequence of events:
1. IS-IS control plane 214 advertises an LSP L1 containing a redistributed route R from BGP to network device 102's IS-IS neighbors (i.e., network device 104).
2. Hitless reboot is initiated on network device 102, which causes both IS-IS control plane 214 and BGP control plane 222 to be restarted.
3. Upon bootup, IS-IS control plane 214 completes its convergence before BGP control plane 222 does; accordingly, IS-IS control plane 214 generates and advertises a post-restart LSP L2 to network device 104 that does not include redistributed route R (because BGP control plane 214 has not converged at that point and thus has not yet synchronized the BGP routes in RIB 218 to LSDB 216).

The outcome of this sequence is that network device 104 will see post-restart LSP L2 excludes redistributed route R, which was included in pre-restart LSP L1. As a result, network device 104 will erroneously withdraw (i.e., delete) route R from its LSDB/RIB, leading to network instability and traffic loss/disruption. This problem is particularly common in the case where BGP is the routing protocol being redistributed, because BGP typically takes longer to converge than IS-IS.

### 2. Solution Overview

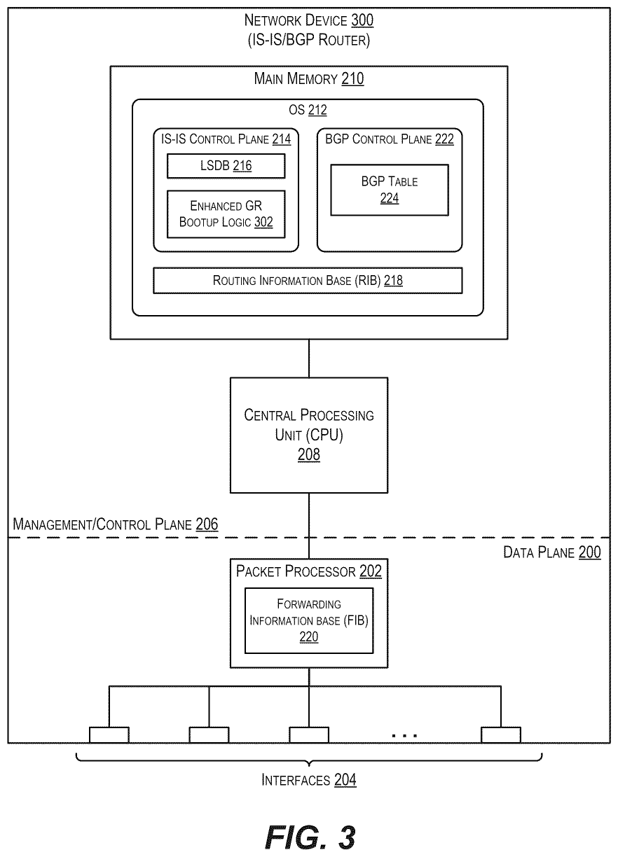

To address the foregoing and other similar/related problems, FIG. 3 depicts a modified version 300 of network device 102 of FIG. 2 according to certain embodiments. As shown, network device 300 includes an enhanced GR bootup logic component 302 in IS-IS control plane 214. Enhanced GR bootup logic 302 may be embodied in program code that is executable by a processor of network device 300, such as CPU 208.

At a high level, enhanced GR bootup logic 302 enables IS-IS control plane 214 of network device 300 to delay the transmission (or in other words, advertisement) of the post-restart LSP to the device's IS-IS neighbors until all other routing protocols running on device 102, such as BGP, have reconverged. As noted previously, BGP control plane 222 and other similar routing protocol control planes are configured to synchronize their routes from RIB 218 to LSDB 216 at the conclusion of their convergence processing (if route redistribution for that protocol to IS-IS is enabled). Accordingly, by waiting to advertise the post-restart LSP until convergence is complete for every other routing protocol, IS-IS control plane 214 can ensure that the post-restart LSP includes all redistributed routes that were advertised to the IS-IS neighbors prior to the hitless reboot. This in turn prevents the IS-IS neighbors from inadvertently withdrawing those routes and avoids the resulting downstream issues.

It should be appreciated that FIGS. 1-3 and the foregoing high-level solution description are illustrative and not intended to limit embodiments of the present disclosure. For example, although these figures and description focus on a scenario where BGP is redistributed into IS-IS, the techniques described herein are equally applicable to scenarios where other routing protocols such as OSPF, EIGRP, and so on are redistributed into IS-IS. Accordingly, all references to “BGP” and “BGP routes” in the present disclosure can be substituted with the more generic terms “routing protocol” and “routing protocol routes.”

Further, although FIG. 3 depicts a particular arrangement of components in network device 300, other arrangements are possible (e.g., the functionality attributed to a particular component may be split into multiple components, components may be combined, etc.). One of ordinary skill in the art will recognize other similar modifications, variations, and alternatives.

### 3. Enhanced IS-IS GR Bootup Processing

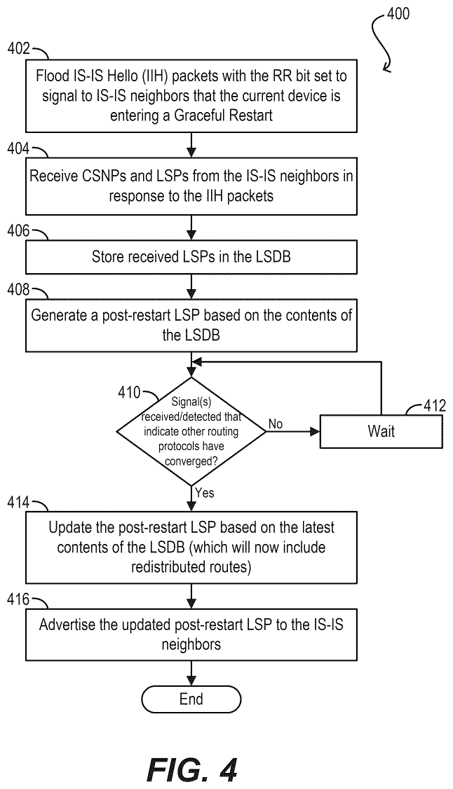

FIG. 4 depicts a workflow 400 of a portion of the GR bootup processing that may be executed IS-IS control plane 214 of network device 300 using enhanced GR bootup logic 302 according to certain embodiments. Workflow 400 is carried out at the time IS-IS control plane 214 is booted up as part of a hitless reboot.

Starting with step 402, IS-IS control plane 214 can broadcast (i.e., flood) a set of IIH packets with the RR bit set to signal to the IS-IS neighbors of network device 300 that device 300 is entering a IS-IS Graceful Restart.

At step 404, IS-IS control plane 214 can receive a CSNP and an LSP from each IS-IS neighbor in response to the IIH packets flooded at step 402 (per the normal IS-IS GR process). IS-IS control plane 214 can then store the received LSPs in LSDB 216 (step 406) and generate a post-restart LSP based on the contents of LSDB 216 (step 408).

Upon generating the post-restart LSP, IS-IS control plane 214 can check whether it has received/detected one or more notification signals indicating that the other routing protocols running on network device 300 (such as, e.g., BGP) have completed their respective restart processing and have converged (step 410). In one set of embodiments, these notification signal(s) may be generated by OS 212. In another set of embodiments, these notification signal(s) may be generated by the respective control planes of those other routing protocols.

If the answer at step 410 is no (i.e., the notification signal(s) have not yet been received/detected), IS-IS control plane 214 can enter a wait state for a certain period of time (step 412) and return to step 410 at the end of that period in order to re-execute the check.

However, if the answer at step 410 is yes (i.e., the notification signal(s) have been received/detected), IS-IS control plane 214 can conclude that LSDB 216 has been updated with redistributed routes from the other routing protocols (because those other protocols are now converged) and can update the post-restart LSP based on the latest contents of LSDB 216 (step 414).

Finally, at step 416, IS-IS control plane 214 can advertise the updated post-restart LSP to the IS-IS neighbors of network device 300 and workflow 400 can end.

It should be noted that workflow 400 is illustrative and various modifications are possible. For example, although workflow 400 indicates that IS-IS control plane 214 generates an initial version of the post-restart LSP, waits for the notification signal(s) indicating that the other routing protocols have converged, and then updates the post-restart LSP after receiving the notification signal(s), in alternative embodiments IS-IS control plane 214 may wait to generate the post-restart LSP until after it has received the notification signal(s).

As another example, although workflow 400 states that the notification signal(s) received/detected by IS-IS control plane 214 indicate whether all other routing protocols running on network device 300 have converged, in some embodiments these notification signal(s) may pertain only to the other routing protocols for which route redistribution to IS-IS is enabled. For instance, if network device 300 runs BGP and OSPF in conjunction with IS-IS and route redistribution to IS-IS is enabled solely for BGP, IS-IS control plane 214 may only receive/detect (and thus, only wait for) a notification signal indicating that BGP has converged. This approach prevents IS-IS control plane 214 from waiting for OSPF to converge before advertising the post-restart LSP (which is not needed because OSPF-to-IS-IS route redistribution is not enabled).

To provide a concrete example of workflow 400, consider a scenario where (1) IS-IS control plane 214 advertises an LSP L1 containing a redistributed route R from BGP to network device 300's IS-IS neighbors (i.e., network device 104), and (2) a hitless reboot is subsequently initiated on network device 300, which causes both IS-IS control plane 214 and BGP control plane 222 to be restarted. In this scenario, the execution of workflow 400 will result in the following:
1. Upon bootup, IS-IS control plane 214 sends an IIH packet to network device 104, receives an LSP from device 104 in response, and stores the LSP in LSDB 216.
2. IS-IS control plane 214 generates a post-restart LSP L2 comprising the contents of LSDB 216.
3. IS-IS control plane 214 waits for a notification signal indicating that BGP has converged.
4. IS-IS control plane 214 receives the notification signal.
5. IS-IS control plane 214 updates post-restart LSP L2 with the latest contents of LSDB 216, which now includes redistributed route R from BGP (because BGP control plane 222 has converged and synchronized the BGP routes in RIB 218 to LSDB 216).
6. IS-IS control plane 214 sends post-restart LSP L2 (including redistributed route R) to network device 104.
7. Network device 104 receives post-restart LSP L2, sees that the LSP includes the previously learned route R, and maintains R in its LSDB/RIB (rather than withdrawing it).

The above description illustrates various embodiments of the present disclosure along with examples of how aspects of these embodiments may be implemented. The above examples and embodiments should not be deemed to be the only embodiments and are presented to illustrate the flexibility and advantages of the present disclosure as defined by the following claims. For example, although certain embodiments have been described with respect to particular workflows and steps, it should be apparent to those skilled in the art that the scope of the present disclosure is not strictly limited to the described workflows and steps. Steps described as sequential may be executed in parallel, order of steps may be varied, and steps may be modified, combined, added, or omitted. As another example, although certain embodiments may have been described using a particular combination of hardware and software, it should be recognized that other combinations of hardware and software are possible, and that specific operations described as being implemented in hardware can also be implemented in software and vice versa.

The specification and drawings are, accordingly, to be regarded in an illustrative rather than restrictive sense. Other arrangements, embodiments, implementations, and equivalents will be evident to those skilled in the art and may be employed without departing from the spirit and scope of the present disclosure as set forth in the following claims.

1. A method performed by a network device that runs Intermediate System to Intermediate System (IS-IS) protocol, the method comprising, at the time of booting up a control plane of the network device as part of a hitless reboot:
receiving one or more link-state packets (LSPs) from one or more neighbor devices;
updating a link-state database (LSDB) based on the one or more LSPs;
generating a post-restart LSP based on contents of the LSDB;
waiting for one or more signals indicating that one or more other routing protocols running on the network device have converged; and
upon receiving or detecting the one or more signals:
updating the post-restart LSP based on latest contents of the LSDB; and
advertising the updated post-restart LSP to the one or more neighbor devices.

2. The method of claim 1 wherein route redistribution from at least a first routing protocol in the one or more other routing protocols to the IS-IS protocol is enabled on the network device.

3. The method of claim 2 wherein the latest contents of the LSDB include one or more routes redistributed from the first routing protocol to the IS-IS protocol.
The method of claim 3 wherein the updated post-restart LSP includes the one or more routes.

5. The method of claim 4 wherein, prior to receiving or detecting the one or more signals, the generated post-restart LSP does not include the one or more routes.

6. The method of claim 2 wherein the one or more routes were advertised by the network device via an LSP to the one or more neighbor devices prior to the hitless reboot.

7. The method of claim 6 wherein, upon receiving the updated post-restart LSP, each neighbor device determines that the one or more routes are present in the updated post-restart LSP and refrains from withdrawing the one or more routes.

8. The method of claim 1 wherein the one or more signals are generated by an operating system (OS) running on the network device.

9. The method of claim 1 wherein the one or more other routing protocols include Border Gateway Protocol (BGP), Open Shortest Path First (OSPF), and/or Enhanced Interior Gateway Routing Protocol (EIGRP).

10. A network device comprising:
a data plane; and
a control plane including a central processing unit (CPU) and a main memory, the main memory having stored thereon program code that when executed by the CPU causes the CPU to, at a time of booting up the control plane as part of a hitless reboot:
receive one or more link-state packets (LSPs) from one or more neighbor devices;
update a link-state database (LSDB) based on the one or more LSPs;
generate a post-restart LSP based on contents of the LSDB;
wait for one or more signals indicating that one or more other routing protocols running on the network device have converged; and
upon receiving or detecting the one or more signals:
update the post-restart LSP based on latest contents of the LSDB; and
advertise the updated post-restart LSP to the one or more neighbor devices.

11. The network device of claim 10 wherein route redistribution from at least a first routing protocol in the one or more other routing protocols to the IS-IS protocol is enabled on the network device.

12. The network device of claim 11 wherein the latest contents of the LSDB include one or more routes redistributed from the first routing protocol to the IS-IS protocol.

13. The network device of claim 12 wherein the updated post-restart LSP includes the one or more routes.

14. The network device of claim 13 wherein, prior to receiving or detecting the one or more signals, the generated post-restart LSP does not include the one or more routes.

15. The network device of claim 11 wherein the one or more routes were advertised by the network device via an LSP to the one or more neighbor devices prior to the hitless reboot.

16. The network device of claim 15 wherein, upon receiving the updated post-restart LSP, each neighbor device determines that the one or more routes are present in the updated post-restart LSP and refrains from withdrawing the one or more routes.

17. The network device of claim 10 wherein the one or more signals are generated by an operating system (OS) running on the network device.

18. The network device of claim 10 wherein the one or more other routing protocols include Border Gateway Protocol (BGP), Open Shortest Path First (OSPF), and/or Enhanced Interior Gateway Routing Protocol (EIGRP).

19. A method performed by a network device that runs Intermediate System to Intermediate System (IS-IS) protocol and another routing protocol different from the IS-IS protocol, the method comprising, at the time of booting up a control plane of the network device as part of a hitless reboot:
generating a post-restart LSP based on contents of a link-state database (LSDB); and
refraining from advertising the post-restart LSP to one or more IS-IS neighbor devices of the network device until the network device has received or detected a signal indicating that said another routing protocol has converged,
wherein route redistribution from said another routing protocol to the IS-IS protocol is enabled on the network device.

20. The method of claim 19 wherein the advertised post-restart LSP includes one or more routes redistributed from said another routing protocol to the IS-IS protocol.
